(19) United States
(12) Patent Application Publication
(10) Pub. No.: US 2001/0055985 A1
(43) Pub. Date: Dec. 27, 2001

(54) Telephoning and hands-free speech for cordless final apparatus with echo compensation

(75) Inventors: Hans Jurgen Matt, Remseck (DE); Michael Walker, Baltmannsweiler (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/884,228

(22) Filed: Jun. 20, 2001

(30) Foreign Application Priority Data
Jun. 21, 2000 (DE) 100 30 548.2

(51) Int. Cl. H04M 1/00

(52) U.S. Cl. 455/570; 455/296; 455/283

(57) ABSTRACT

A process for operating a cordless TC final apparatus with a device for compensating acoustic echoes between loudspeaker and microphone comprises the following steps:

a) defining various operating situations (Bi) of the TC final apparatus;

(b) detecting sets of parameters (Pi) for compensating acoustic echoes for every operating situation (Bi) and storing them in a memory unit to which the TC final apparatus has access;

(c) selecting the current operating situation (Bj) after switching on the TC final apparatus or in the event of a change in the operating situation;

(d) loading the set of parameters (Pj) pertaining to the current operating situation (Bj) from the memory unit into the device for compensating acoustic echoes and carrying out the echo compensation with the loaded set of parameters (Pj) as a start value.

The speech quality may be considerably improved thereby. In particular, a rapid adaptation to the instantaneous speech or operating situation can be made and therefore the function of hands-free speech can be executed more efficiently and reliably. The process also contributes to avoidance of feedback whistling and reverberation and to making a full-duplex process and a reduced noise level possible.

The invention relates to a process for operating a cordless telecommunications (=TC) final apparatus, in particular a mobile telephone, with a device for compensating acoustic echoes between loudspeaker and microphone of the TC final apparatus and hardware subassemblies for carrying out the process.

Cordless telephones, in particular mobile telephones, are increasingly popular. To achieve decent quality of communication in apparatuses with constantly decreasing dimensions and therefore increasing acoustic coupling of loudspeaker to microphone, these apparatuses usually have devices for compensating acoustic echoes. The technology of the adaptive filter for echo compensation is described, for example, in DE 44 30 189 Al.

To increase the level of handling comfort of cordless TC final apparatuses, these have recently acquired devices for hand-free speech. Hands-free speech denotes a form of speech communication in which the loudspeaker of the final apparatus can be turned up very high volume-wise, wherein the apparatus is, for example, on a table and the user “can speak hands-free”, i.e. without having to hold a handset to his ear.

There is a particularly strong coupling from loudspeaker to microphone with this form of communication as, owing to the high volume of the loudspeaker, a stronger signal than the signal of the local speaker arrives at the microphone from the loudspeaker. Unpleasant feedback whistling can then occur which makes communication impossible. Communication can also be disturbed in that while the unit is not whistling it is very echoey, i.e. scraps of conversation can echo strongly.

Recently, mobile telephone final apparatuses have been becoming smaller and smaller. Therefore, loudspeaker and microphone have inevitably been moving closer and closer together with the result that the signal of the local speaker, and therefore the signal of the microphone, receives the desired signal of the local speaker only weakly but, unfortunately, receives the interfering signal from the loudspeaker very strongly. Particularly small mobile telephones can therefore no longer manage without additional measures. They would be unusable if it were not for a group of measures designed to reduce this acoustic coupling of loudspeaker to microphone such that operation is possible.

The known measures designed to reduce the loudspeaker-microphone coupling include

a) the use of Backelectret microphones to compensate structure-borne noise;

b) the strongly damped mounting of microphone and loudspeaker in the housing, for example on a soft and therefore damping silicone ring;

c) an airtight as possible encapsulation of the loudspeaker in the housing to avoid as far as possible an acoustic short circuit;

d) the distance between loudspeaker and microphone can be increased by a flap which has to be opened on a mobile phone; or by a spacing pin for the microphone.

d) Measures for signal processing, for example use of

1. adaptive filters for compensating the interfering signal portions in the microphone signal.

2. automatic selection control,

3. high-resolution analogue-digital converters (>14 bit/sample),

4. soft clippers for limiting peak signal values,

5. two or more microphones with successive signal processing.

The signal processing methods only work reasonably reliably if the analogue-digital converters (A/D converter) downstream of the microphone have a sufficiently large resolution (≈16 bit/sample) in order, on the one hand to digitise the peak signal values of the loudspeaker signal at the microphone (>110 dB) cleanly (without overdriving) and, on the other hand, to still provide enough bits for the comparatively weak mean signal level (≈68 dB) of the local speaker, so the speech of the local speaker does not additionally lose quality owing to quantisation noises.

The use of adaptive filters for echo compensation is, as already mentioned at the outset, described, for example in DE 44 30 189 Al.

If an FIR (=finite impulse response) filter is adjusted with an NLMS algorithm then the filter coefficients can momentarily be falsely adjusted if

a) an insufficient “spectral white signal” is emitted,

b) the filter attempts to adjust a different signal to the echo, for example

if sinusoidal tones are emitted,

in the event of talk-back speech (double talk detected incorrectly or detected too late),

in the event of interfering excess noises,

in the event of non-linear distortions.

For this reason it is proposed in DE 44 30 189 Al that not only one continuous determination of the filter coefficients is carried out, but that in addition, an evaluation of the quality of the filter coefficients and a measurement of the error signal is made. If a better set of filter coefficients is found then this set is taken up in the active filter.

The disadvantage of the known processes for noise suppression is, however, that after the TC final apparatus is switched on and/or after a modification to the impulse response of the space or of the apparatus, the algorithm for adjusting the filter attempts to find a new setting and when using the conventional algorithms a certain time frame is required for this purpose which is generally deemed to be interfering as short whistling and squeaking tones can occur.

If, on top of that, the acoustic environment is filled with noise the filter algorithm cannot determine the filter coefficients precisely enough. The period up until a convergence is then also extended further.

If, moreover, the loudspeaker in a TC final apparatus, for example a mobile telephone, rattles particularly strongly because it is “turned up fully” and the housing causes additional vibrations (rattlings etc.), the algorithm again cannot find a good end adjustment. The speech quality then remains atrocious.

The object of the present invention is therefore to present a process with the features described at the outset in which the above-mentioned disadvantages of known operating processes are avoided or, at least, considerably toned down The rapid adjustment to the instantaneous speech situation or operating situation should, in particular, be able to take place and therefore, for example, the function of the hands-free speech be carried out more efficiently and reliably. Finally, the process should contribute to the avoidance of feedback whistling and reverberation and should allow a full-duplex process and a reduced noise level.

According to the invention this object is achieved in a manner which is as simple as it is effective by the following process steps:

(a) defining various operating situations (Bi) of the TC final apparatus;

(b) detecting sets of parameters (Pi) for compensating acoustic echoes for every operating situation (Bi) and storing them in a memory unit to which the TC final apparatus has access;

(c) selecting the current operating situation (Bj) after switching on the TC final apparatus or in the event of a change in the operating situation;

(d) loading the set of parameters (Pj) pertaining to the current operating situation (Bj) from the memory unit into the device for compensating acoustic echoes and carrying out the echo compensation with the loaded set of parameters (Pj) as a start value.

By defining suitable operating situations and determining the associated optimised sets of parameters before beginning echo compensation, a compensation can be made which is considerably quicker, more efficient and much better adapted to the current situation, from which the function of hands-free speech profits in particular.

The three operating modes of a mobile telephone which are currently the most important are:

(i) the mobile phone is held in the hand and loud hands-free speech is switched on

(ii) the mobile phone is on the table and the hands-free speech device is switched on.

(iii) the mobile phone is inserted in a special holding device, generally in a vehicle, and switched to hands-free speech.

Therefore, an embodiment of the process according to the invention is particularly preferred in which in step (a) the three higher order operating situations (Bi) are defined, namely:

B1: TC final apparatus is held in the user's hand;

B2: TC final apparatus lies or stands on a stationary base;

B3: TC final apparatus is fixed in a holding device.

The advantage of this definition consists in that it imitates the particularly important situations, which often occur in practice, and in that suitably good (and in practice generally very different from one another) sets of parameters are determined in advance and stored in a memory for these technically very different situations. Therefore, the length of the adaptive filter for echo compensation, for example, can be adjusted quite differently for the three above-described operating modes, namely in accordance with the length of the impulse response for each of these operating modes.

A further improvement to this embodiment may be achieved in that in a step (a1) at least one subordinate operating situation (B11, B12, . . . ; B21, B22, . . . ; B31, B32, . . . ) is defined for each higher order operating situation (B1, B2, B3) which confirms the corresponding higher order operating situation, for example,

B11: TC final apparatus is held by the user to his ear;

B12: TC final apparatus is held by the user in front of the stomach or the chest;

B21: TC final apparatus is on a table with the operating side facing the user;

B22: TC final apparatus is on a table with the operating side upwards;

B23: TC final apparatus is on a table with the operating side facing the table;

B31: TC final apparatus is inserted in a holding device in a vehicle;

B32: TC final apparatus is inserted in a base cradle.

The definition of these subordinate operating situations pertaining to the higher order operating situations serves to refine the sets of parameters in order to achieve even better hands-free speech quality.

In a further preferred embodiment of the process according to the invention at least a portion of the sets of parameters (Pi) are determined by calculation, preferably by simulation calculations, in step (b). A simulation on a computer is generally less expensive than protracted measurements. However, appropriate sets of parameters should only be determined by means of simulation if the level of precision achievable thereby is sufficient.

If a simulation is too unreliable, because, for example, a part of the system may not be modelled in a simple manner, or if simulation results already obtained are to be stored, the parameters can also be verified metrologically. For this purpose, at least a portion of the sets of parameters (Pi) is determined experimentally, preferably by measuring the operating behaviour of a TC final apparatus in the operating situations defined in step (a) or (a1) in a further variation of the process in step (b).

A development of this variation of the process is characterised in that the sets of parameters (Pi) are determined by measurements on various TC final apparatuses of the same type and subsequent averaging of the measured values obtained. If system parameters of the microphones, loudspeakers, housings etc. used are widely scattered during production it can be advantageous to determine scatterings of this kind by means of measurements in order to find a favourable compromise for the parameters from the distribution of these scatterings.

If different but similar models of a mobile telephone are produced then such compromise sets of parameters can be determined by measurements on various TC final apparatuses of comparable, at least similar type, and subsequent averaging of the measured values obtained. The fewer variations of sets of parameters for on-going productions which have to be used, the less expensive the production and therefore the lower the error rate will be.

Weighted averaging can also take place in these process variations in accordance with certain criteria. Such a weighted averaging of measured and/or simulated sets of parameters serves to reduce the variation for a production process.

An operating situation can be communicated to the electronics of the mobile telephone in various ways. The simplest and cheapest method (but not necessarily always the best) is an adjustment by hand via keys, cursor plus click command or via a speech command if the mobile telephone can recognise speech commands.

A method which is more comfortable for the user but which is technically more complicated, consists in automatic detection of the operating situation and direct communication thereof to the electronics.

Various situations can, for example, be used for automatic detection of operating situations, such as pressure, position, infrared sensors and other types of proximity detectors which can determine the distance of the user from the TC final apparatus. The better the sensor arrangement works, the more reliably estimation of a current operating situation can take place.

A further embodiment of the process according to the invention which is characterised in that a plurality of, preferably all of the sets of parameters stored in step (b) are loaded successively or simultaneously and therefore a compensation of acoustic echoes is made respectively, in that the results of the various echo compensations are compared with one another, and in that the set of parameters with the best result is selected for further compensation of acoustic echoes, is particularly preferred.

If there is sufficient computing power in the TC final apparatus, additional sensors and the costs and error rates associated therewith can optionally be dispensed with in that the electronics quietly emit a synthetic noise signal from the loudspeaker and soon after run through all available sets of parameters for echo compensation and then the most favourable set of parameters for the current echo compensation can be determined in the process with the aid of a quality value (for example, value of the residual echo after the adaptive filter). Therefore, the operating situation is indirectly detected immediately.

In order to allow the electronics an “approach” which is as simple as possible in a variation of the process any of the stored sets of parameters (Pi) is loaded in step (d) as start value independent of the current operating situation (Bj).

In particular, the set of parameters (Pi) pertaining to the operating situation B1 can be loaded irrespective of the current operating situation (Bj) as start value in step (d) The starting position in which the user holds the TC apparatus in the hand, must generally be the most probable. It can, however, also be advantageous, for example with a TC final apparatus frequently or constantly installed in a vehicle, to load, for example, the set of parameters pertaining to the operating situation B3 as preadjusted start value.

An embodiment of the process according to the invention is also particularly preferred, in which the device for compensating acoustic echoes comprises an adaptive filter which continuously adapts the set of parameters loaded as a start value to the current acoustic environment situation of the TC final apparatus, in particular by appropriate modification of the filter coefficients.

During actual operation the acoustic impulse response is influenced by the smallest changes in the position of the apparatus or surrounding articles. Therefore, it is expedient and advantageous to allow an automatically further adapting algorithm for the filter coefficients to run in order to be able to constantly balance residual echoes to a minimum. The advantage of this consists in that the algorithm does not have to calculate the coefficients starting from a “zero” set, but that it can adjust a new operating mode much more quickly owing to the preadjustment and also achieves a fine adjustment for this situation much more quickly.

In a particularly advantageous variation of this embodiment at least one portion of the adapted sets of parameters is stored in a learning memory during operation of the TC final apparatus and is used again in subsequent applications.

It is very advantageous to temporarily store the sets of parameters whose product of “quality value times duration” exceeds a specific threshold value for a subsequent use. These sets of parameters can subsequently serve in a learning process to slowly improve the sets of parameters stored in advance. Such a learning process can, on the one hand, at least partially intercept or compensate ageing of critical components such as loudspeaker, microphone etc., but equally scatterings of the parameters of critical components during production.

In a further advantageous development it is provided that the device for compensating acoustic echoes comprises at least two adaptive filters, of which one is used for the instantaneous compensation of acoustic echoes and optionally as a reference, the other filter(s) is each used to search for a set of filter coefficients better suited to compensating acoustic echoes, and that when a better set of filter coefficients is found this is used for further compensation of acoustic echoes. When using two filters the first filter can constantly search for a set of filter coefficients which is better in terms of instantaneous quality, and if such a set is found can load this into the second filter which is used for compensating the echoes.

A further improvement may be achieved in that the respective delay time of a set of filter coefficients used for compensating acoustic echoes is measured, the delay times of various sets of filter coefficients are evaluated statistically and the sets of filter coefficients with the longest delay times are stored in a learning memory as sets of parameters particularly suited to the corresponding operating situation.

The sets of parameters can, for example, be assessed in terms of their quality according to the size of the residual echo. However, this is not sufficient on its own as the duration for which a set of parameters is particularly good (mean service life) is not taken into account here. Therefore it is advantageous to evaluate the sets of parameters in accordance with their product of “quality times duration” and to only continue to use those with the greatest value for the learning process.

The above-described process variations can therefore be further refined in that the sets of filter coefficients weighted by the respective delay time are stored in the learning memory.

Finally, a considerable improvement in an embodiment of the process according to the invention can be achieved in that the volume at the loudspeaker of the TC final apparatus is adjusted automatically as a function of the respective current operating situation (Bj).

A server unit, a processor subassembly and a gate array subassembly to support the above-described process according to the invention and a computer programme for carrying out the process also fall within the context of the present invention. The process can be achieved both by a hardware circuit and in the form of a computer programme. Nowadays, software programming is preferred for powerful DSP's as new discoveries and additional functions can be implemented more easily by a modification to the software on the basis of existing hardware. Processes can, however, also be implemented as hardware modules, for example in TC final apparatuses or telephone systems.

A device for compensating acoustic echoes between loudspeaker and microphone of a cordless TC final apparatus which has a signal input for the TC signal arriving at the loudspeaker and a further signal input for the TC signal leaving the microphone and in which one processor is provided which can calculate by means of an algorithm correction signals for compensating acoustic echoes while taking into account the signals at its two signal inputs, which correction signals can be passed from the device to the TC line issuing from the microphone, characterised in that the processor has a connection to a memory unit with the stored sets of parameters (Pi) from which it loads a selected set of parameters (Pj) and can therefore calculate the correction signals for compensating acoustic echoes, also falls within the context of the present invention.

The device according to the invention preferably contains at least one adaptive filter, preferably a FIR (=finite impulse response) filter for calculating the correction signals.

It is particularly preferred in the device according to the invention to provide an expander or a compander downstream of an adaptive filter as an addition. The compander process is known, for example, from DE 42 29 912 Al. A reduction in noise can be carried out therewith, the degree of which is determined in accordance with a strictly undertaken transfer function.

The compander initially has the property of transferring speech signals with a specific, “normal speech signal level” adjusted in advance virtually unchanged from its input to the output. If, however, the input signal is too loud, for example because a speaker is too close to the microphone, then a dynamic compressor limits the output level to virtually the same value as in the normal case, in that the current amplification is linearly reduced in the compander with increasing input volume. As a result of this property the speech at the output of the compander system is approximately of uniform volume irrespective of how strongly the input volume fluctuates. If, on the other hand, a signal with a level which is smaller than that of the normal level is passed to the input of the compander, then the signal is additionally damped in that the amplification is pegged back in order to transfer background noises so they are as attenuated as possible. The expander/compander can also eliminate residual echoes contained in the signal very efficiently and can therefore correct momentary malfunctions of the adaptive filter connected upstream.

An embodiment of the device according to the invention is also preferred in which for compensating acoustic echoes write and read access to a learning memory is possible in which improved sets of parameters can be stored.

In order to allow manual input of the operating situation Bj, it is provided in embodiments that the device for compensating acoustic echoes is connected to an input unit, in particular a switch, for example a pushbutton for inputting the current operating situation (Bj) selected in step (c), arranged on the TC final apparatus.

In order to allow the above-described automatic implementation of the selection of the current operating situation in step (c) it is provided in a preferred embodiment of the device according to the invention that the device for compensating acoustic echoes is connected to at least one sensor arranged on the TC final apparatus which can supply characteristic data for the current physical environment of the TC final apparatus in order to determine the current operating situation (Bj).

The sensor can, in particular, be a touch sensor with which it can be established which situation, in particular in which position, the TC final apparatus is.

Therefore, the sensor can be sensitive to pressure and/or electrical conductivity and can therefore establish whether the user is holding the TC final apparatus in his hand or whether it is, for example, standing or lying on a table.

The TC final apparatus with the device according to the invention can advantageously have a right parallelepiped shape, one of the two opposing largest faces, which are connected to one another by four smaller lateral faces, being the operating side of the TC final apparatus with the input unit for the call numbers and at least one sensor being arranged on each of the two longitudinal sides in order to be able to determine the precise position of the TC final apparatus on a base (standing or lying, loudspeaker directed upwards or toward the base etc.).

An embodiment of the invention in which the sensor has mechanical and/or electrical switches for recognising an installation situation of the TC final apparatus, for example in a holding device in a vehicle or in a cradle or on a bracket for mounting the TC final apparatus on a base, can also be advantageous. As a result, a changeover, for example, can be made immediately to a variation of the operating process, in which a set of parameters pertaining to the operating situation B3 is loaded as start value, without manual intervention.

Finally, an infrared sensor can be incorporated in the device according to the invention with which inter alia the distance of the TC final apparatus from the user or to an echo-reflecting wall can be determined and corresponding parameters to the relevant operating situation can be determined automatically.

Further advantages of the invention can be derived from the description and the drawings. The above-mentioned features and the features explained in more detail according to the invention can also each be used individually or in any combination. The embodiments shown and described are not to be seen as a conclusive list but rather are examples which illustrate the invention.

The invention will be described in more detail with the aid of embodiments, and is illustrated in the drawings, in which:

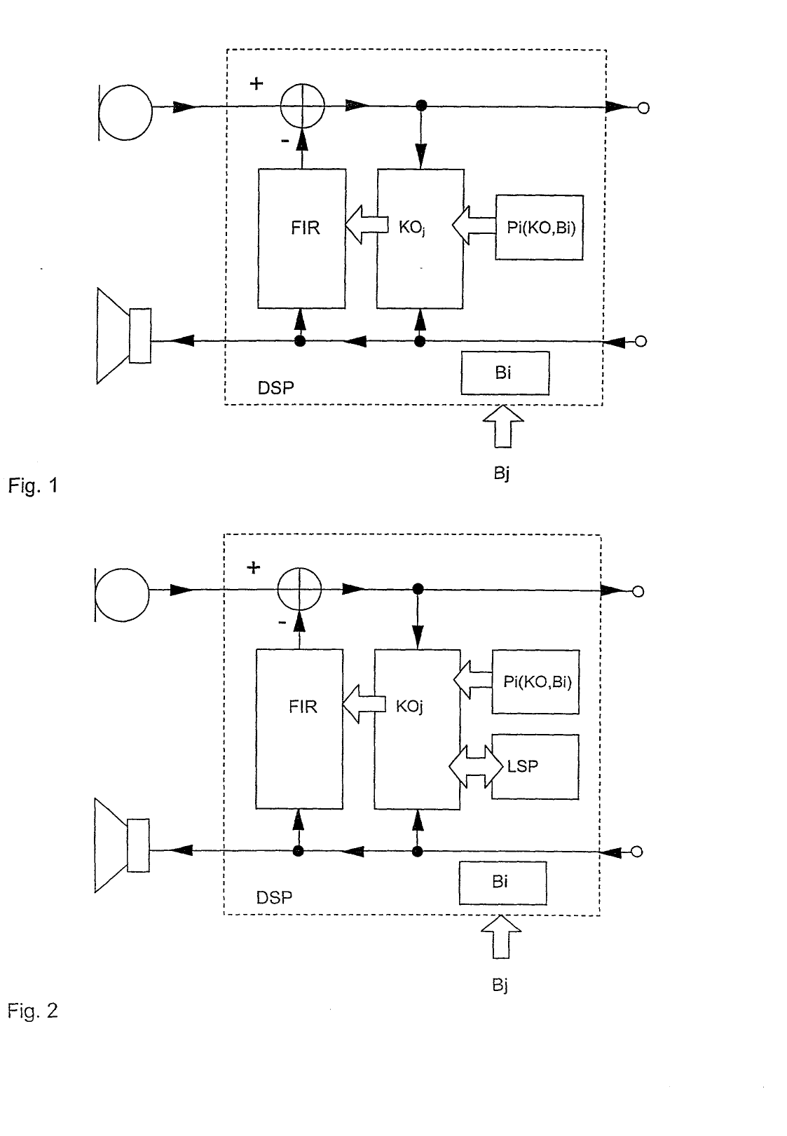

FIG. 1 shows a diagrammatic view of the operating mode of a device for carrying out a first, simple variation of the process according to the invention;

FIG. 2 shows a second variation of the invention with learning memory;

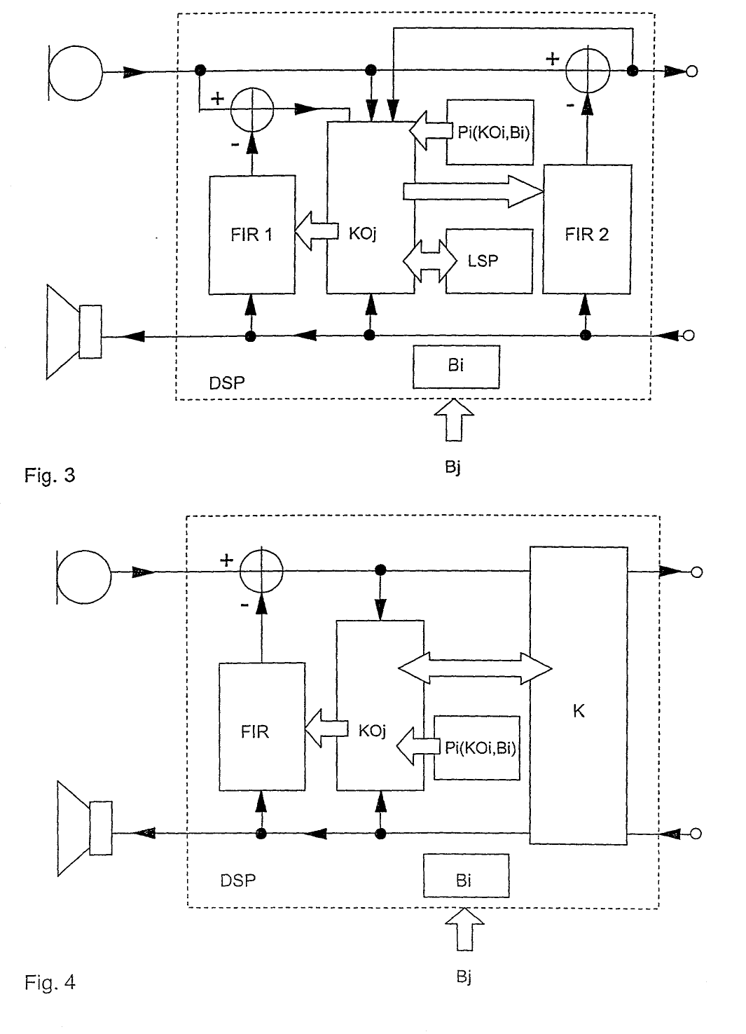

FIG. 3 shows a third variation of the invention with two parallel FIR filters; and

FIG. 4 shows a fourth variation of the invention with compander/expander.

A digital signal processor DSP which is connected on the one hand to a TC final apparatus, which is represented in the drawing by a microphone and a loudspeaker symbol, and on the other hand has an incoming and outgoing signal line in a TC network not shown in detail, is shown in dashed lines in the functional diagram of FIG. 1.

In addition to the four incoming and outgoing signal lines there is also an input means for a current operating situation Bⱼ of the TC final apparatus provided at the digital signal processor DSP and indicated by an arrow. This input of the current operating situation Bⱼ can either be made by hand or automatically by sensors (not shown in the drawings). On the basis of the appropriate input the operating situation corresponding best of all to the current operating situation Bⱼ is selected from a memory from a number of different defined, preset operating situations Bᵢ. The corresponding set of parameters Pⱼ (Bⱼ) is then selected from a memory for sets of parameters Pᵢ, which are each clearly associated with an operating situation Bᵢ, and input into a memory for filter coefficients KO. A set of filter coefficients KOⱼ corresponding to this input set of parameters Pⱼ is selected on the basis thereof, which set of filter coefficients is passed to a FIR (=finite impulse response) filter.

In the FIR filter, a correction value for the TC signal coming from the microphone is calculated using an algorithm (for example NLMS=normalised least mean square or RLMS=recursive least mean square) with the aid of the input filter coefficients KOⱼ and the outgoing signal is loaded with this correction value. In this way, acoustic echoes between loudspeaker and microphone can be compensated effectively or at least reduced to a bearable level.

For the event that there is a very good signal-to-noise ratio (S/N) in the signal coming from the microphone, in the embodiment according to FIG. 2 the sets of filter coefficients KOⱼ (Bⱼ) for the respective operating mode Bⱼ evaluated as “particularly good” with regard to echo reduction (measured in dB) and optionally further characterising parameters are stored in a learning memory LSP. In addition, the duration tⱼ for which the algorithm evaluated the respective set of coefficients KOⱼ as “very good” can also be stored. A first statistical evaluation of the sets of coefficients KOᵢ stored in the learning memory LSP is made at the end of each conversation at the latest. Here it is checked a) which are the best sets of filter coefficients KOᵢ (Bᵢ), b) over which period tᵢ these sets of filter coefficients KOᵢ (Bᵢ) were used respectively, and c) how great the background noise (or the signal-to-noise ratio S/N) was in each of the sets of filters, as only the best sets of filter coefficients KO with as good a signal-to-noise ratio as possible are to be used for the further evaluation.

The selected sets of filter coefficients KOᵢ (Bᵢ) stored in the learning memory LSP are then arranged in a new sequence according to the greatest product from a quality value (for example as a function of the size of the echo reduction in dB) times the duration tᵢ for a certain operating mode Bᵢ (or a corresponding sub-mode). This product is compared with the product of the set of coefficients KOᵢ (Bᵢ) originally loaded for the same operating mode Bᵢ. If the new product is greater than that stored, then the original set of coefficients KOᵢ (Bᵢ) is replaced by the new set of coefficients. In this way the apparatus is taught a type of learning ability. It can be achieved hereby that the TC final apparatus can better adapt to a new operating state as a result, that the initial setting of the FIR filter via the input set of coefficients KOᵢ (Bᵢ) corresponds as closely as possible to the situation occurring most frequently.

If there are up to, for example, three slightly different sets of coefficients contained in the learning memory LSP for each of the defined operating modes Bᵢ then the best measured values respectively may also be compared with one another over a plurality of conversations and therefore the most favourable initial setting for the set of filter coefficients KO respectively may be determined from a plurality of conversations.

In addition to the embodiment according to FIG. 2 a further adaptive filter is provided in FIG. 3. The filter FIR 2 serves to instantaneously compensate acoustic echoes and optionally as a reference, whereas the filter FIR 1 is used to search for a set of filter coefficients KO better suited to compensating acoustic echoes in each case. When a better set of filter coefficients is found this is immediately used to further compensate acoustic echoes in the filter FIR 2.

Finally, the embodiment according to FIG. 4 comprises, in addition to an adaptive filter, a compander K or an expander in accordance with the known state of the art. The advantages of using a compander unit with regard to noise reduction has already been discussed above. The combination with a compander can induce an echo suppression up to 50 dB in particular in conjunction with a FIR filter which reduces the signal-to-noise ratio S/N to a value near 0 dB.

Of course a plurality of further combinations of features of the above-described embodiments is also possible and of particular advantage for specific applications.

1. A process for operating a cordless telecommunications (=TC) final apparatus, in particular a mobile telephone, with a device for compensating acoustic echoes between loudspeaker and microphone of the TC final apparatus,
characterized by the following steps:
(a) defining various operating situations (Bi) of the TC final apparatus;
(b) detecting sets of parameters (Pi) for compensating acoustic echoes for every operating situation (Bi) and storing them in a memory unit to which the TC final apparatus has access;
(c) selecting the current operating situation (Bj) after switching on the TC final apparatus or in the event of a change in the operating situation;
(d) loading the set of parameters (Pj) pertaining to the current operating situation (Bj) from the memory unit into the device for compensating acoustic echoes and carrying out the echo compensation with the loaded set of parameters (Pj) as a start value.

2. A process as claimed in claim 1, wherein three higher order operating situations (Bi) are defined in step (a), namely:
B1: TC final apparatus is held in the user's hand;
B2: TC final apparatus lies or stands on a stationary base;
B3: TC final apparatus is fixed in a holding device.

3. A process as claimed in claim 1, wherein in step (b) at least a portion of the sets of parameters (Pi) is determined by calculation, preferably by simulation calculations.

4. A process as claimed in claim 1, wherein in step (b) at least a portion of the sets of parameters (Pi) is determined experimentally, preferably by measuring the operating behaviour of a TC final apparatus in the operating situations defined in step (a) or (a1).

5. A process as claimed in claim 4, wherein sets of parameters (Pi) are determined by measurements on various TC final apparatuses of comparable, at least similar type and subsequent averaging of the measured values obtained.

6. A process as claimed in claim 1, wherein the current operating situation (Bj) is selected manually in step (c), by the TC final apparatus user.

7. A process as claimed in claim 1, wherein the current operating situation (Bj) is selected automatically in step (c), and in that the current physical environmental situation of the TC final apparatus is determined by a sensor and is evaluated for automatic selection of the operating situation (Bj).

8. A process as claimed in claim 1, wherein a plurality of, preferably all of the sets of parameters stored in step (b) are loaded successively or simultaneously and therefore a compensation of acoustic echoes is made in each case, in that the results of the various echo compensations are compared with one another, and in that the set of parameters with the best result is selected for further compensation of acoustic echoes.

9. A process as claimed in claim 8, wherein any of the stored sets of parameters (Pi) is loaded in step (d) as start value independent of the current operating situation (Bj).

10. A process as claimed in claim 1, wherein the device for compensating acoustic echoes comprises an adaptive filter (FIR) which constantly adapts the set of parameters loaded as start value, in particular by appropriate modification of the filter coefficients (KO), to the current acoustic environment situation of the TC final apparatus.

11. A process as claimed in claim 10, wherein at least one portion of the adapted sets of parameters is stored during operation of the TC final apparatus in a learning memory and is used again in subsequent applications.

12. A process as claimed in claim 10, wherein the device for compensating acoustic echoes comprises at least two adaptive filters (FIR 1, FIR 2) of which one (FIR 1) is used for the instantaneous compensation of acoustic echoes and optionally as a reference, the other filter(s) (FIR 2) is each used to search for a set of filter coefficients (KO) better suited to compensating acoustic echoes, and in that when a better set of filter coefficients is found this is used for further compensation of acoustic echoes.

13. A process as claimed in claim 12, wherein the respective delay time tᵢ of a set of filter coefficients (KOᵢ) used for compensating acoustic echoes is measured, the delay times of various sets of filter coefficients are evaluated statistically and the sets of filter coefficients with the longest delay times are stored in a learning memory (LSP) as sets of parameters particularly suited to the corresponding operating situation.

14. A process as claimed in claim 13, wherein the sets of filter coefficients (Koᵢ) weighted with the respective delay time tᵢ are stored in the learning memory (LSP).

15. A process as claimed in claim 1, wherein the volume at the loudspeaker of the PC final apparatus is automatically adjusted as a function of the respective current operating situation (Bj).

16. A device for carrying out the process as claimed in claim 1 for compensating acoustic echoes between loudspeaker and microphone of a cordless TC final apparatus which has a signal input for the TC signal arriving at the loudspeaker and a further signal input for the TC signal leaving the microphone and in which the one processor is provided which can calculate by means of an algorithm correction signals for compensating acoustic echoes while taking into account the signals at its two signal inputs, which correction signals can be passed from the device to the TC line issuing from the microphone, characterised in that the processor has a connection to a memory unit with the stored sets of parameters (Pi) from which it loads a selected set of parameters (Pj) and can therefore calculate the correction signals for compensating acoustic echoes.

17. A device as claimed in claim 16, wherein at least one adaptive filter, preferably a FIR filter (FIR; FIR 1, FIR 2) is provided for calculating the correction signals and/or an expander or a compander (K) is provided.

18. A device as claimed in claim 16, wherein the device for compensating acoustic echoes is connected to an input unit, in particular a switch, for example a pushbutton for inputting the current operating situation (Bj) selected in step (c), arranged on the TC final apparatus.

19. A device as claimed in claim 18, wherein the device for compensating acoustic echoes is connected to at least one sensor arranged on the TC final apparatus which can supply characteristic data for the current physical environment of the TC final apparatus in order to determine the current operating situation (Bj).

20. A device as claimed in claim 19, wherein the sensor has mechanical and/or electrical switches for recognising an installation situation of the TC final apparatus, for example in a holding device in a vehicle or in a cradle or on a bracket for mounting the TC final apparatus on a base.
